(19) United States
(12) Patent Application Publication
(10) Pub. No.: US 2025/0065696 A1
(43) Pub. Date: Feb. 27, 2025

(54) WINDSHIELD COVER

(71) Applicant: HUSSNAIN HUSSAIN, SCHENECTADY, NY (US)

(72) Inventor: HUSSNAIN HUSSAIN, SCHENECTADY, NY (US)

(21) Appl. No.: 18/812,537

(22) Filed: Aug. 22, 2024

Related U.S. Application Data
(60) Provisional application No. 63/578,311, filed on Aug. 23, 2023.

(51) Int. Cl. B60J 1/20

(52) U.S. Cl. CPC B60J 1/2019; B60J 1/2072; B60J 1/2077

(57) ABSTRACT

Provided is a windshield cover with a retractable roll mountable to a first A pillar of a vehicle; and one or more anchors located on a second A pillar of the vehicle; wherein the retractable roll is movable from an initial retracted position to an extended position, and when in the extended position, the retractable roll is attached to the one or more anchors to secure the retractable roll in the extended position, thereby forming a cover across a windshield of the vehicle between the first A pillar and the second A pillar An associated method is also provided.

### CROSS REFERENCE TO RELATED APPLICATIONS

This application claims priority to the previously submitted provisional application with the following details: Inventor: Hussnain A. Hussain; Application No. 63/578,311; Filing Date: Aug. 23, 2023; Title: Windshield Cover.

### FIELD OF TECHNOLOGY

The following relates to a windshield cover, and more specifically to embodiments of a cover that can be mounted to a vehicle.

### BACKGROUND

A windshield cover is desirable to protect the windshield of a vehicle from the elements, such as rain, snow, sunlight, and the like. Attaching and using a windshield cover can be a daunting task because of lack of reliable and convenient mounting and storage options. For example, if a windshield cover is to be mounted to a vehicle windshield, one has to first make space to store the windshield cover, most commonly in the trunk of the vehicle, then retrieve the windshield cover, and then use some ropes or bands to tie it to the vehicle. After the need for the windshield cover is met, one must remove it away from the windshield, and store it away, most commonly in the trunk of the vehicle. Considerable effort is spent in all these steps, and one must expose oneself to the elements for a long time until all the steps are completed, making the entire process unpleasant.

Thus, a need exists for a cover that can be securely mounted to a vehicle.

### SUMMARY

A first aspect relates to a retractable roll mountable to a first A pillar of a vehicle; and one or more anchors located on a second A pillar of the vehicle wherein the retractable roll is movable from an initial retracted position to an extended position, and when in the extended position, the retractable roll is attached to the one or more anchors to secure the retractable roll in the extended position, thereby forming a cover across a windshield of the vehicle between the first A pillar and the second A pillar.

A second aspect relates to a vehicle comprising a first A pillar having at least one anchor machined into a surface of the first A pillar, the at least one anchor of the first A pillar configured to anchor a retractable roll; and a second A pillar having at least one anchor machined into a surface of the second A pillar; wherein, when the retractable roll is anchored to the at least one anchor of the first A pillar, a cover material is extendable from the retractable roll to cover a windshield of the vehicle and be anchored to the at least one anchor of the second A pillar.

A third aspect relates to a method of machining at least one anchor point into a first A pillar and at least one anchor point into a second A pillar so that a retractable roll is mountable to the at least one anchor point of the first A pillar.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a front view of a vehicle windshield showing the top and bottom edges, as well as the left and right edges commonly known as A pillars, windshield glass, and a plurality of anchors;

FIG. 2 depicts a front view of a vehicle windshield showing the top and bottom edges, as well as the left and right edges commonly known as A pillars, a plurality of anchors, and a Retractable roll overlaid on the windshield, windshield;

FIG. 3 depicts a front view of a vehicle windshield showing the top and bottom edges, as well as the left and right edges commonly known as A pillars, and a windshield cover housing mounted on the passenger side of the windshield, more particularly mounted on the passenger side A pillar, a windshield cover housing enclosure, windshield glass, a plurality of anchors, a Retractable roll overlaid on the windshield;

FIG. 4 depicts various parts of the windshield cover housing, and the windshield cover housing enclosed by the windshield cover housing enclosure, in accordance with embodiments of the present invention;

FIG. 5 Shows a transverse section of various parts of windshield cover housing, and Windshield Cover Housing enclosed by Windshield Cover Housing Enclosure, and windshield Cover Housing Mounting Point, wherein the Windshield Cover Housing Mounting Point secures to the A Pillar, via a plurality of anchors as shown in other figures, and also shows Windshield Cover Housing Enclosure Hinge, in accordance with embodiments of the present invention;

FIG. 6 depicts a Vehicle Windshield, bound on the left and right sides by A pillars, namely the passenger side A pillar and the driver side A pillar, and a plurality of anchors, the anchors further differentiated as left side anchors and right side anchors, in accordance with embodiments of the present invention;

FIG. 7 Shows various parts of a first Windshield Cover Housing, mountable on A Pillar Passenger Side, and Windshield Cover Housing enclosed by Windshield Cover Housing Enclosure, and second Windshield Cover Housing, and Windshield Cover Housing enclosed by Windshield Cover Housing Enclosure, mountable on A Pillar Driver Side. The Windshield Cover Housing, and Windshield Cover Housing enclosed by Windshield Cover Housing Enclosure, intended to be mounted on A Pillar Driver Side, does not depict the Retractable roll contained within it, but instead has a plurality of Deployment Cable connected to Windshield Cover spindle, the Windshield Cover spindle is powered by a Deployment motor. The plurality of Deployment Cable has its other end connected to Windshield Cover attachment member, whereby the winding of the plurality of Deployment Cable causes the Windshield Cover Attachment member to move towards A Pillar Driver Side, thereby causing the Retractable roll to unwind, and cover the Windshield Glass, in accordance with embodiments of the present invention;

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

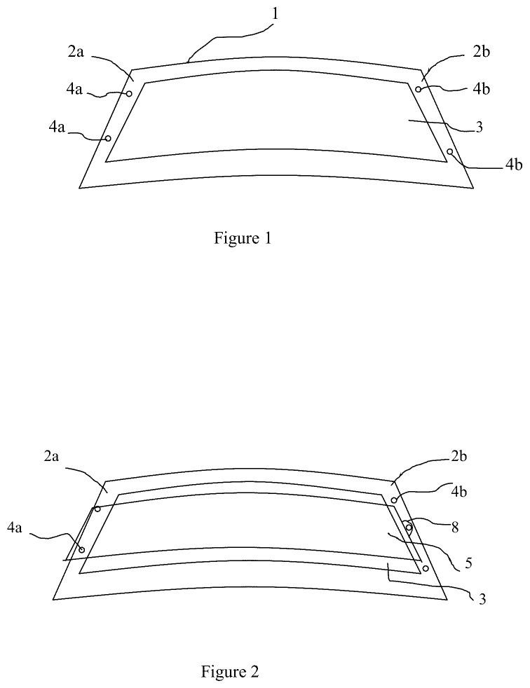

Referring now to the drawings, FIG. 1 depicts a front view of a vehicle windshield showing the top and bottom edges, as well as the left and right edges commonly known as A pillars, in accordance with embodiments of the present invention. As illustrated in FIG. 1, the A pillar on the left side is the A pillar Passenger side 2a, and the A pillar on the right is the A pillar Driver side 2b. The A pillars are named this way from the perspective of the driver of a vehicle, and A pillar Driver side 2b, is closest of the driver's seat in a vehicle, while the A pillar Passenger side 2a is closest to the passenger's seat in a vehicle. FIG. 1 also shows a plurality of anchors namely left anchor 4a, and right anchor 4b in accordance to the embodiments of the present disclosure. Left anchor 4a is located on the passenger side A pillar, and the Right anchor 4b is located on the driver side A pillar. Although a plurality of anchors 4a and 4b are shown in FIG. 1, a single or several anchor 4a or 4b could be used respectively, depending on the specific configuration of the windshield cover and/or vehicle how the present invention is practiced. As per the present disclosure, the anchors 4a and 4b are integrated into the A pillars of a vehicle windshield to allow attaching of the windshield cover or its components. In some embodiments of the present invention, a person skilled in the art may choose any of the following as anchors: mechanical fasteners, nuts, bolts, rivets, rivet style nuts, hook and loop fasteners, magnets, electromagnets, pegs, friction fittings, orings, clips, circlips, expansion rings, springs, glue, adhesives, epoxies, caulk, etc, or a combination thereof. Since a choice of anchors is wide, one may choose to use a threaded nut with a hollow center, which in turn may allow electric wires to travel between the interior of the vehicle to the exterior of the vehicle, and in turn connect to parts of the Windshield cover of the present invention, to allow transfer of electric power between the vehicle and the Windshield cover as needed. The Windshield cover of the present invention utilizes anchors 4a and 4b to securely secure the Windshield cover to the A pillars of a vehicle. In an exemplary embodiment, a first anchor 4a, is machined or embedded at a specific standardized point on the A pillar of the vehicle, and a second anchor 4a is machined or embedded on the same A pillar of a vehicle, wherein the distance between the first and second anchor 4a is a standardized distance, such as 10 millimeters, 100 millimeters, or 200 millimeters, or a multiple of 10 millimeters. Such an arrangement will allow for all vehicle manufactures to follow a standard, and the manufacturing of the windshield cover can also follow a standardization regarding its mounting to the vehicle. The same procedure may be followed regarding the other A pillar of the vehicle. In an alternate embodiment, multiple anchors may be used, and the distance between them can be standardized.

Referring now to the drawings, FIG. 2 depicts a front view of a vehicle windshield showing the top and bottom edges, as well as the left and right edges commonly known as A pillars, in accordance with embodiments of the present invention. Also seen are A pillar Driver side 2b, and A pillar Passenger side 2a, and the retractable roll as an embodiment of the present invention. FIG. 2 simply depicts that the retractable roll covers the width of the windshield glass 3 of the vehicle. The retractable roll may be made of an appropriately desirable material. Examples of materials that retractable roll may be made out of are cloth, textile, nylon, polymers, natural fibers, synthetic fibers, carbon fibers, nanotechnology fibers, films, solar cell films, and the like, or a combination of any of the examples in the disclosure. The present invention also allows for use of materials such as ballistic nylon, bulletproof fabric, bulletproof materials, heat reflective materials, radiation reflective materials, nuclear fallout protective materials, heat absorbing materials, hydrophobic materials, hydrophilic materials, translucent, or transparent, or opaque materials, continuous or perforated materials, and the like. The choice of materials is not limited to the list as described infra.

Moreover, embodiments of the windshield cover may differ based on the intended purpose. For example, during camping, it may be desirable that retractable roll is made of dark and opaque materials to enhance privacy. In an off-road driving usage, or military use, the present invention may use retractable roll made of a perforated hydrophobic material to keep dirt and debris off the windshield of the car or vehicle, while also aiding visibility. The strength of the material may be chosen per the usage.

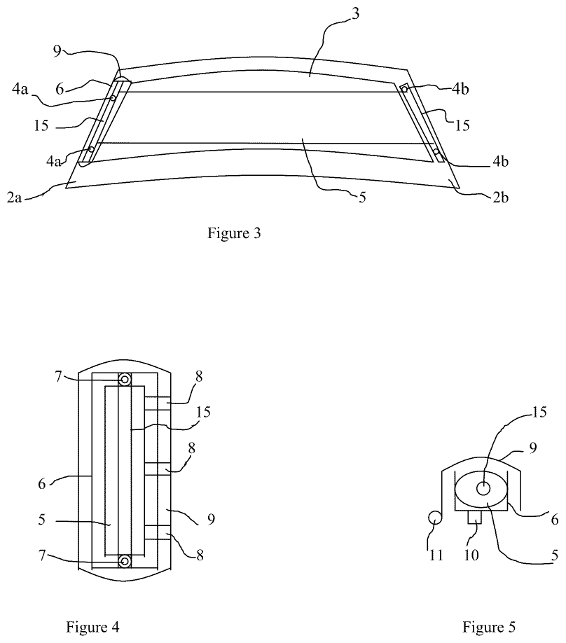

FIGS. 2-3 depict a front view of a vehicle windshield showing the top and bottom edges, as well as the left and right edges commonly known as A pillars, and a windshield cover housing 6 mounted on the passenger side of the windshield, more particularly mounted on the A pillar passenger side 2a, windshield glass 3, A pillar driver side 2b, and a plurality of anchors 4a and 4b. It should be understood that in an alternative embodiment of the present invention, windshield cover housing 6 can be mounted on the driver side of the windshield to A pillar driver side 2b. In yet another embodiment of the present invention, it should be understood that windshield cover housing 6 can be mounted on both the driver as well as the passenger side of the windshield, to A pillar driver side 2b and A pillar passenger side 2a respectively.

In yet another embodiment of the present invention, windshield cover housing 6 can be mounted on A pillar driver side 2b and instead of mounting on A pillar passenger side 2a, a windshield cover housing 6 is mounted on surface of windshield glass 3 of a vehicle.

In yet another embodiment of the present invention, windshield cover housing 6 can be mounted on A pillar passenger side 2a, and instead of mounting on A pillar driver side 2b, a windshield cover housing 6 is mounted on surface of windshield glass 3 of a vehicle. Such arrangements will allow retractable roll to cover less than the complete surface of windshield glass 3. In other words, the size and shape, and location of retractable roll can be adjusted to cover either entirely or partially the surface of windshield glass 3.

FIG. 4 shows various parts of Windshield Cover Housing 6, and depicts how Windshield Cover Housing 6 is enclosed by Windshield Cover Housing Enclosure 9. Also seen in FIG. 4. are Retractable roll, Windshield Cover Retracting spring 7, Attachment member 8, Windshield Cover Anchor Point 12, and Windshield Cover spindle 15. The retractable roll when rolled up forms a roll like a rolled carpet. As is commonly understood, when a continuous fabric is rolled up, such as a rolled up carpet, a roll has an innermost layer with subsequent layers overlapping the immediate layer before it, until the entire length of the fabric is rolled up. In such an arrangement, the innermost layer will have a starting free edge of the fabric, and the last layer will have a free edge which one may call the ending free edge. As will now be clear from the above explanation, the Retractable roll when rolled up forms a roll depicted as Retractable roll. The inner starting free edge of Retractable roll is mechanically connected to Windshield Cover spindle 15. One or both ends of Windshield Cover spindle 15 may be connected to a Windshield Cover Retracting spring 7. Windshield Cover Retracting spring 7 in this embodiment is a circular spring, which is mechanically connected to Windshield Cover spindle 15 in such a way that it is in the unwound state when Retractable roll is in its rolled up state. Windshield Cover Retracting spring 7 in this embodiment is a circular spring, which is mechanically connected to Retractable roll in such a way that it is in the wound state when Retractable roll is in its unrolled up state or when it is pulled out or stretched out to cover the windshield glass 3. In other words, when Retractable roll is deployed to cover a windshield, the Windshield Cover Retracting spring 7 becomes wound up, and exerts a force on the Retractable roll 5 so as to tend to roll it up. It is much like circular watch spring mechanism, where in the present embodiment, the Windshield Cover Retracting spring 7 has a tendency or tends to exert a force on Retractable roll 5 so as to retract it into the Windshield Cover Housing 6. To further clarify, a circular spring can be compared to a thin rolled up belt. The innermost layer end of a circular spring can be connected to one structure, and the outermost layer end of a circular spring can be connected to another structure. Movement of one such structure in relation to the other structure, when such movement is around the longitudinal axis of the circular spring, will cause the winding or unwinding of the circular spring. One with reasonable skill in the art will understand this arrangement readily and will be able to employ Windshield Cover Retracting spring 7 in an embodiment of this invention to allow the pulling out and retraction of Retractable roll 5. Retractable roll 5 may be pulled out of Windshield Cover Housing 6 by applying a pulling force on Attachment member 8. Attachment member 8 can be gripped by hand or in an alternate embodiment, a plurality of Attachment member 8 may be pulled by a cable or similar structure. Once Retractable roll 5 is deployed by pulling on Attachment member 8 by overcoming the force exerted by Windshield Cover Retracting spring 7, and Retractable roll 5 is extended so as to cover the desired portion of windshield glass 3 of a vehicle or the entire windshield glass 3 of a vehicle, the Retractable roll 5 can then be held in place by engaging Attachment member 8 onto the opposite A pillar of a vehicle. Examples of Attachment member 8 are carabiners, keyholes, flexible loops, rigid loops, hooks, claws, nuts, bolts, rivets, rivet style, hook and loop fasteners, magnets, electromagnets, pegs, friction fittings, orings, clips, circlips, expansion rings, springs, glue, adhesives, epoxies, caulk, etc. In this particular embodiment, Attachment member 8 engages to Anchor 4b on the opposite A pillar of the vehicle. In other words, if Retractable roll 5 is mounted on A pillar passenger side 2a, then the opposite side A pillar will be A pillar driver side 2b. The Attachment member 8 in this case can be a flexible loop which may engage on to Anchor 4b which in turn is a peg. Other embodiments may use hook and loop or magnets for such engagement. Once such engagement is complete, the Retractable roll 5 will be in a fully extended or deployed position to so as to cover the windshield glass 3. Retractable roll 5 can stay in this state until a single or plurality of Attachment member 8 is disengaged from Anchor 4b which in this example of the embodiment is a peg.

FIG. 5 shows various parts of Windshield Cover Housing 6, and depicts how Windshield Cover Housing 6 is enclosed by Windshield Cover Housing Enclosure 9. Also shown in FIG. 5 are Retractable roll 5, Windshield Cover spindle 15, Windshield Cover Housing Mounting Point 10, and Windshield Cover Housing Enclosure Hinge 11. In one embodiment, Windshield Cover Housing Mounting Point 10 can be a bracket or a boxed structure attached to Windshield Cover Housing 6 as shown in FIG. 5. In another embodiment, Windshield Cover Housing Mounting Point 10 can be a drilled hole through which a threaded bolt can be passed through and secured to Anchor 4a such as a threaded nut. As should be understood, the number of Windshield Cover Housing Mounting Point 10 depends on the requirements of the user. The positioning of Windshield Cover Housing Mounting Point 10 and number can be determined also to match with the positioning and number Anchor 4a or 4b. The choice of types and materials for Windshield Cover Housing Mounting Point 10 and Anchor 4a or 4b or any other materials used in this invention will depend on various factors of design. Windshield Cover Housing 6 is enclosed by Windshield Cover Housing Enclosure 9 while leaving a space for Retractable roll 5 to be pulled out and deployed. Windshield Cover Housing Enclosure 9 has a Windshield Cover Housing Enclosure Hinge 11 which allows Windshield Cover Housing Enclosure 9 to pivot on it thereby allowing the Windshield Cover Housing Enclosure 9 to be elevated or raised off or lowered on to Windshield Cover Housing 6. It will be understood that the Retractable roll 5 will be pulled out from the opposite side of the location of the Windshield Cover Housing Enclosure Hinge 11. Windshield Cover Housing Enclosure Hinge 11 can be a friction type hinge or spring loaded, or motorized to allow for remote activation. Windshield Cover Housing Enclosure 9 can be painted or colored to compliment or match the color of the vehicle it is mounted on. Windshield Cover Housing Enclosure 9 can also be shaped in a complimentary shape for aesthetics, or aerodynamic shape to reduce wind noise or drag while mounted on a vehicle.

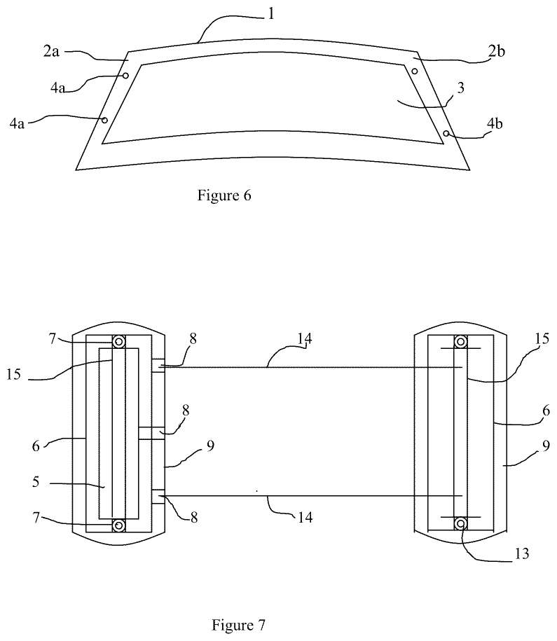

Referring now to FIGS. 3, 6 and 7, a first Windshield Cover Housing 6 is mounted to A Pillar Passenger Side 2a, and a second Windshield Cover Housing 6 is mounted to A Pillar Driver Side 2b, and the first Windshield Cover Housing 6 is enclosed by Windshield Cover Housing Enclosure 9, and second Windshield Cover Housing 6 is not shown to be enclosed in FIG. 3 but it may be so covered if chosen. The first Windshield Cover Housing 6 is enclosed by Windshield Cover Housing Enclosure 9. Also seen are the Retractable roll 5, spindle 15, Retracting spring 7, Attachment member 8. The second Windshield Cover Housing 6 mountable on A Pillar Driver Side 2b, does not depict the Retractable roll 5 contained within it, but instead has a plurality of Deployment Cable 14 connected to Windshield Cover spindle 15. Windshield Cover spindle is powered by a Deployment motor 13. The plurality of Deployment Cable has its other end connected to a plurality Windshield Cover attachment member 8, whereby the pulling on or winding of the plurality of Deployment Cable 14 causes the Windshield Cover Attachment member to move towards A Pillar Driver Side 2b, thereby causing the Retractable roll 5 to unwind, and cover the Windshield Glass, in accordance with embodiments of the present invention. The Deployment motor 13 can be powered by electrical power supplied from inside a vehicle, and controlled by a toggle switch, or automatic controller, relays, an application on a handheld device, cellular device, remote control, or a combination thereof. A mechanical, electromechanical, electronic, optical or any other kind of sensor may be employed in conjunction with the Deployment Motor 13, and upon the sensing of a certain location, stimulus, or environmental parameter, such sensor may activate the Deployment Motor 13.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

1. A windshield cover comprising:
a retractable roll mountable to a first A pillar of a vehicle; and
one or more anchors located on a second A pillar of the vehicle;
wherein the retractable roll is movable from an initial retracted position to an extended position, and when in the extended position, the retractable roll is attached to the one or more anchors to secure the retractable roll in the extended position, thereby forming a cover across a windshield of the vehicle between the first A pillar and the second A pillar.

2. The windshield cover of claim 1, wherein, when the retractable roll is released from the one or more anchors, the retracted roll automatically retracts back into the retracted position.

3. The windshield cover of claim 1, wherein the retractable roll is mountable to at least one fastener at least partially embedded into the first A pillar.

4. The windshield cover of claim 1, wherein the retractable roll includes a housing that houses a roll of cover material wound around a spindle, the spindle being mechanically connected to a retracting spring within the housing to exert a retracting force to urge the roll back around the spindle when moved from the retracted position.

5. The windshield cover of claim 1, wherein the retractable fabric roll further comprises at least one attachment member that is configured to mechanically engage with the at least one anchor located on the second A pillar.

6. The windshield cover of claim 5, wherein the at least one attachment member is selected from the group consisting of: a hook, a latch, a carabiner, keyhole, flexible loop, rigid loop, claws, nut, bolt, rivet, rivet style nut, hook and loop fastener, magnet, electromagnet, peg, friction fitting, o-ring, clip, circlip, expansion ring, spring, glue.

7. The windshield cover of claim 1, wherein the one or more anchors are machined into the second A pillar.

8. The windshield cover of claim 1, wherein the one or more anchors are a fastener mounted to the second A pillar, with a first portion protruding from a surface of the second A pillar and a second portion embedded into the second A pillar.

9. The windshield cover of claim 1, further comprising a motor that drives a movement of the retractable roll between the retracted position and the extended position.

10. The windshield cover of claim 9, wherein the motor drives a spindle located at the second A pillar to draw the retractable roll towards the second A pillar.

11. A vehicle comprising:
a first A pillar having at least one anchor machined into a surface of the first A pillar, the at least one anchor of the first A pillar configured to anchor a retractable roll; and
a second A pillar having at least one anchor machined into a surface of the second A pillar;
wherein, when the retractable roll is anchored to the at least one anchor of the first A pillar, a cover material is extendable from the retractable roll to cover a windshield of the vehicle and be anchored to the at least one anchor of the second A pillar.

12. The vehicle of claim 11, wherein the at least one anchor of the first A pillar includes female threads capable of receiving a fastener that fastens the retractable roll to the first A pillar.

13. The vehicle of claim 11, wherein the at least one anchor of the second A pillar is configured to receive a fastener that extends at least partially into the at least one anchor at one end and is exposed above the surface of the second A pillar at an opposing end.

14. The vehicle of claim 13, wherein an end of the retractable roll engages a portion of the fastener that is exposed above the surface of the second A pillar to anchor the retractable roll in an extended position.

15. The vehicle of claim 1, wherein locations of the at least one anchor on the first A pillar and the at least one anchor on the second A pillar is standardized from one vehicle to another vehicle.

16. A method for comprising:
machining at least one anchor point into a first A pillar and at least one anchor point into a second A pillar so that a retractable roll is mountable to the at least one anchor point of the first A pillar.

17. The method of claim 15, wherein the at least one anchor of the first A pillar includes female threads capable of receiving a fastener that fastens the retractable roll to the first A pillar.

18. The method of claim 15, wherein the at least one anchor of the second A pillar is configured to receive a fastener that extends at least partially into the at least one anchor at one end and is exposed above the surface of the second A pillar at an opposing end.

19. The method of claim 17, wherein an end of the retractable roll engages a portion of the fastener that is exposed above the surface of the second A pillar to anchor the retractable roll in an extended position.

20. The method of claim 1, further comprising: electrically connected a motor of the retractable roll to a power source of the vehicle, such that in response to a user input, the motor is caused to move the retractable toll into an extended position.
